(19) United States
(12) Patent Application Publication
(10) Pub. No.: US 2009/0121043 A1
(43) Pub. Date: May 14, 2009

(54) HORIZONTAL-TYPE ATOMIZING APPARATUS WITH AUTOMATICALLY CONTROLLABLE WORKING FLUID LEVEL

(75) Inventors: Nai Ying JEAN, Hsin Tien City (TW); Wen Pin Chen, Hsin Tien City (TW)

Correspondence Address: LUCAS & MERCANTI, LLP, 475 PARK AVENUE SOUTH, 15TH FLOOR, NEW YORK, NY, 10016, US

(73) Assignee: KAI CHIH INDUSTRIAL Co., Ltd., Hsin Tien City (TW)

(21) Appl. No.: 12/268,990

(22) Filed: Nov. 11, 2008

(30) Foreign Application Priority Data
Nov. 14, 2007 (TW) 096142943

(51) Int. Cl. B05B 12/08; B05B 17/06; B05B 1/08

(52) U.S. Cl. 239/65; 239/102.2; 239/71; 239/379

(57) ABSTRACT

A horizontal-type atomizing apparatus with automatically controlled working fluid level includes a portable horizontal base internally defining a dispensing chamber and an atomizing chamber horizontally opposite to but communicating with each other; a pressure container assembled to the dispensing chamber for supplying a working fluid into the dispensing chamber and the atomizing chamber; and an atomizing module arranged on the base. By utilizing the principle of atmospheric pressure balance, the working fluid in the dispensing chamber is maintained at a constant level, allowing the atomizing module to obtain constant volume of working fluid and constant working load to produce a stable amount of mist containing uniformly-sized droplets. An ambient atmospheric condition sensing unit is included for detecting atmospheric conditions in the environment surrounding the atomizing apparatus, regulating the amount of mist to be produced, and generating a warning signal for timely replenishing the working fluid.

### FIELD OF THE INVENTION

The present invention relates to a horizontal-type atomizing apparatus, and more particularly to a horizontal-type atomizing apparatus that utilizes the principle of atmospheric pressure balance to automatically maintain constant working fluid level and produce stable amount of mist. The atomizing apparatus can be used at anyplace that requires improved air quality or humidity, and the working fluid can be perfume, aromatic, deodorant, insecticide, or any other activating fluids.

### BACKGROUND OF THE INVENTION

An atomizing apparatus can be applied in air humidification, inhalation therapy for dispensing medicine via nose and lungs, and spray therapy for curing eye disease. The atomizing apparatus generally includes a piezoelectric oscillating element for vibrating a perforated mist actuator, so that an external working fluid guided to the mist actuator is oscillated to produce mist. In U.S. Pat. No. 5,518,179 entitled “Fluid Droplets Production Apparatus and Method”, a working fluid in a container is supplied to a perforated membrane via a capillary feed, and a piezoelectric element is used to actuate the perforated membrane, so that the working fluid passing a plurality of tiny holes formed on the perforated membrane is oscillated and dissolved to form fluid droplets. More particularly, the working fluid is absorbed by the capillary feed provided in the container, and fed to a bottom side of the perforated membrane. When the piezoelectric element generates vibration wave to actuate the perforated membrane, a cohesion force of the working fluid on the perforated membrane is destroyed, resulting in differentiation of the working fluid to form droplets. During the process of atomizing, the working fluid is consumed to cause change in the level and accordingly, the volume of the working fluid in the container. As a result, the pressure from the working fluid stored in the container is also changed. Moreover, a distance between the capillary feed and the level surface of the working fluid would also have influence on the quantity of working fluid being absorbed by the capillary feed. When the working fluid level in the container is changed, the amount and the size of the produced droplets would change, too. When a relatively large quantity of working fluid is absorbed and attached to an upper end of the capillary feed, a relatively large load is needed to actuate the perforated membrane. In the event the atomizing apparatus is not adjusted in its power, the high load for actuating and vibrating the perforated membrane would result in production of droplets with relatively large size. On the other hand, when the load is low, the size of the produced droplets is small. That is, the fluid droplets produced by the conventional atomizing apparatus are not uniform in size.

There are still other patents disclosing similar techniques, such as U.S. Pat. No. 5,297,734, Taiwanese Patent Nos. 506855, 510826, 510827, 526098 and 1222899 granted to S.C. Johnson & Sons, Inc., etc.

### SUMMARY OF THE INVENTION

A primary object of the present invention is to provide a horizontal-type atomizing apparatus with automatically controllable working fluid level, so that the working fluid is maintained at a constant level to enable production of constant amount of mist containing uniformly sized droplets. Therefore, it is not necessary to use a mist actuator made of a material having a high capillary density, and the atomizing apparatus can have a prolonged usable life.

Another object of the present invention is to provide a horizontal-type atomizing apparatus with automatically controllable working fluid level, which includes a detecting unit for sensing the level surface of a working fluid in a dispensing chamber of the atomizing apparatus, and informing a user to timely replenish the working fluid.

A further object of the present invention is to provide a horizontal-type atomizing apparatus with automatically controllable working fluid level, which includes an ambient atmospheric condition sensing unit for detecting atmospheric conditions in the environment surrounding the atomizing apparatus, so as to improve the air quality or humidity in a specific place.

A still further object of the present invention is to provide a horizontal-type atomizing apparatus with automatically controllable working fluid level, which includes a mist actuator connected to a piezoelectric element as a cantilever, so that an angle between the mist actuator and the piezoelectric element can be adjusted to thereby change the direction in which mist is produced, enabling the atomizing apparatus to produce mist in different directions.

A still further object of the present invention is to provide a horizontal-type atomizing apparatus with automatically controllable working fluid level, which includes an atomizing module having a fluid guiding member for indirectly guiding the working fluid to a mist actuator for producing mist.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a phantom perspective view of a horizontal-type atomizing apparatus according to a preferred embodiment of the present invention;

FIG. 2 is a side view of the atomizing apparatus of FIG. 1 showing the assembling of a pressure container to a horizontal base thereof;

FIG. 3 is a side view schematically showing the atomizing apparatus of the present invention in operation;

FIGS. 4 to 6 are side views showing some different embodiments of the atomizing apparatus according to the present invention in operation;

FIG. 7 shows an example of opening a sealed mouth of the pressure container for the present invention; and

FIG. 8 is a circuit diagram of a driving circuit for the present invention.

### DETAILED DESCRIPTION OF THE PREFERRED EMBODIMENTS

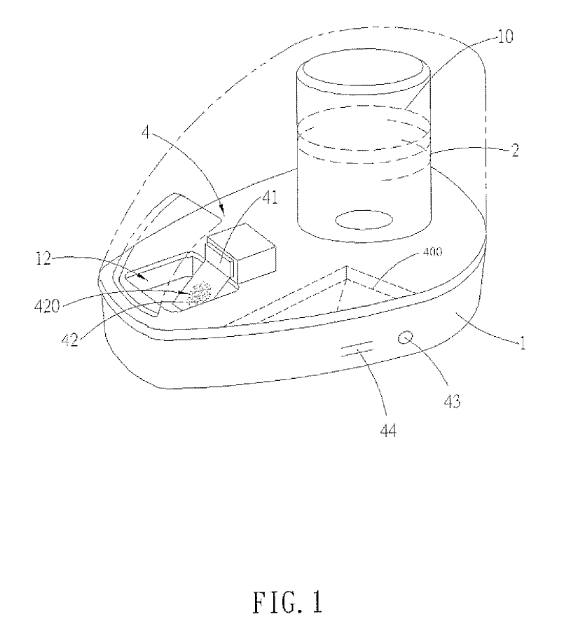

Please refer to FIGS. 1 to 3, in which a horizontal-type atomizing apparatus with automatically controllable working fluid level according to a preferred embodiment of the present invention is shown. The atomizing apparatus of the present invention is designed for horizontally seating on a surface, and utilizes the principle of atmospheric pressure balance and detection of external environmental conditions, so as to automatically regulate the amount of mist that can be produced from a working fluid 10 contained in the atomizing apparatus as well as the duration within which the atomizing apparatus operates continuously, and generate a warning signal when the time for replenishing the working fluid 10 is reached. To achieve these functions, the atomizing apparatus of the present invention includes a portable horizontal base 1, a pressure container 2, and an atomizing module 4.

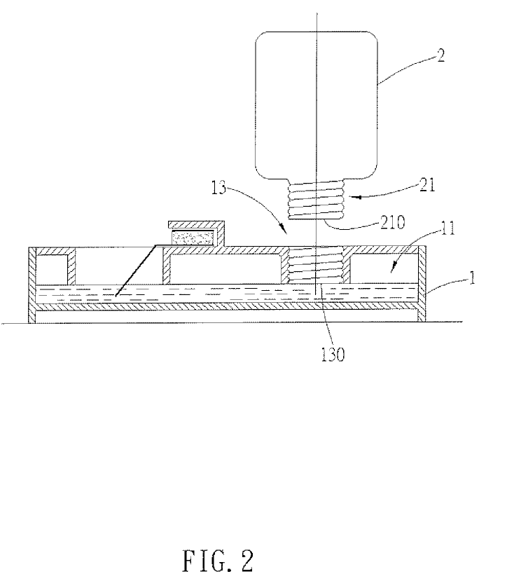

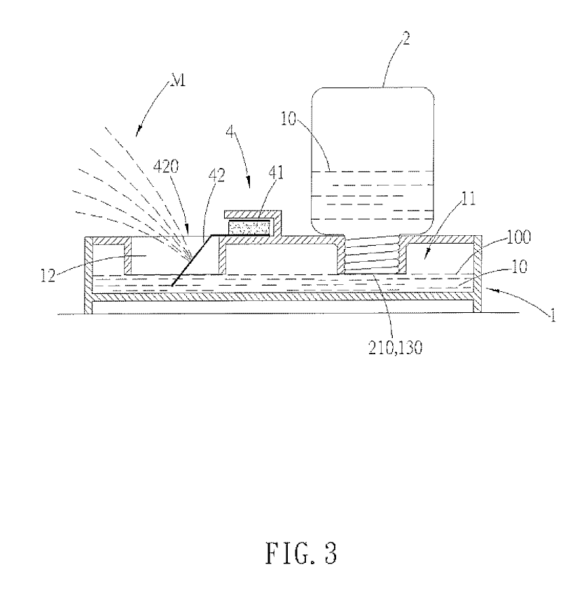

As can be seen from FIGS. 2 and 3, the portable horizontal base 1 defines an inner space for storing an amount of the working fluid 10 therein. A dispensing chamber 11 is formed in the horizontal base 1, and a port 13 is formed on the base 1 atop the dispensing chamber 11, such that a lower end 130 of the port 13 is suspended in the dispensing chamber 11. And, an atomizing chamber 12 is also formed in the horizontal base 1 to locate horizontally opposite to and communicate with the dispensing chamber 11.

The atomizing module 4 is arranged on the horizontal base 1 adjacent to the atomizing chamber 12. Based on the detection of external environmental conditions, the atomizing module 4 produces mist, regulates the duration for producing mist, and informs a user the level of the working fluid 10 stored in the dispensing chamber 11.

The atomizing module 4 includes a power control unit 400, a piezoelectric element 41, a mist actuator 42, and a detecting unit 43.

The power control unit 400 is arranged inside the atomizing module 4 for supplying electric power, controlling the production of mist, and regulating the amount of mist to be produced. The power control unit 400 is able to generate an enable signal, and stops the mist production when receiving a warning signal from the detecting unit 43.

The piezoelectric element 41 provides a vibration source, and produces oscillation energy when receiving the enable signal from the power control unit 400.

The mist actuator 42 is extended into the atomizing chamber 12 to contact with the working fluid 10, and is perforated on a working surface thereof to form a plurality of mist producing holes 420. When receiving the oscillation energy from the piezoelectric element 41, the mist actuator 42 is oscillated to produce mist at the mist producing holes 420.

The detecting unit 43 is arranged below the mist actuator 42 for detecting a level surface 100 of the working fluid 10 in the dispensing chamber 11. When the level surface 100 is lower than a preset value, the detecting unit 43 generates a warning signal.

The mist actuator 42 is connected to the piezoelectric element 41 as a cantilever.

The pressure container 2 is used to contain the working fluid 10 therein, and has a mouth 21 for removably assembling to the port 13. The pressure container 2 assembled to the port 13 is in an upside-down position, guiding the working fluid 10 through the mouth 21 into the dispensing chamber 11.

The atomizing module 4 can further include an ambient atmospheric condition sensing unit 44 for detecting atmospheric conditions in the environment surrounding the atomizing apparatus. When it is detected by the ambient atmospheric condition sensing unit 44 that the ambient atmospheric pressure is lower than a preset value, the power control unit 400 will generate the enable signal for the piezoelectric element 41 to generate the oscillation energy and the mist actuator 42 to oscillate and produce mist continuously. The enable signal stops when an ambient atmospheric pressure higher than the preset value is detected. Then, the detection for ambient atmospheric conditions continues.

The ambient atmospheric condition sensing unit 44 can also detect movements of all objects into and out of the environment surrounding the atomizing apparatus. When it is detected by the ambient atmospheric condition sensing unit 44 that the number of movements of all objects into and out of the ambient environment of the atomizing apparatus is higher than a preset value, the power control unit 400 will generate the enable signal for the piezoelectric element 41 to generate the oscillation energy and the mist actuator 42 to oscillate and produce mist for at least one time.

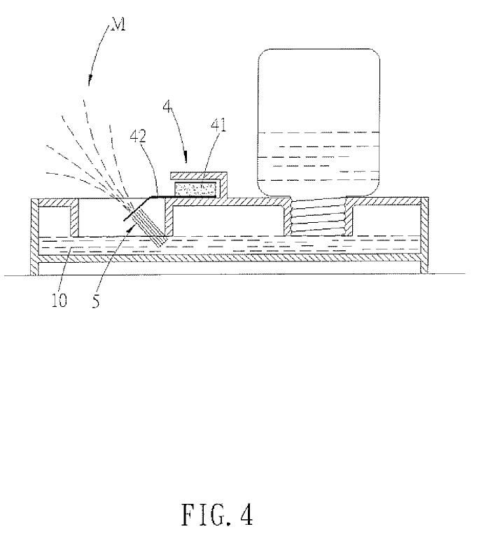

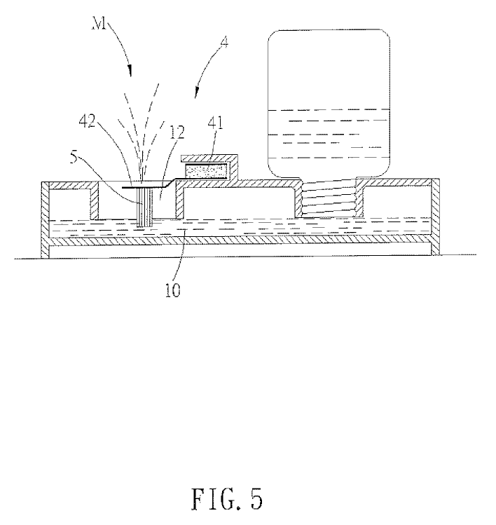

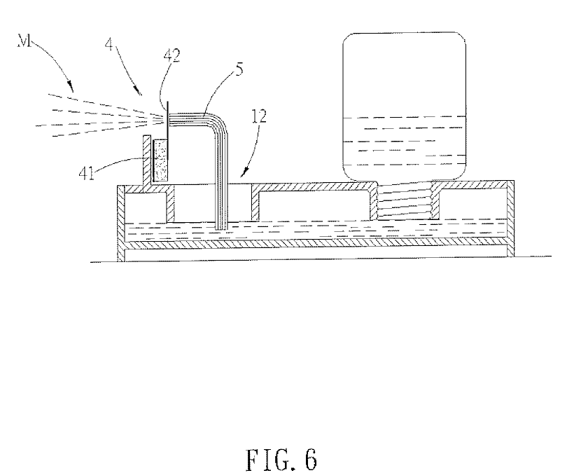

The piezoelectric element 41 can be a round structure, and the mist actuator 42 is provided on a working surface thereof with a plurality of mist producing holes 420 for producing mist. FIGS. 4 to 6 show some other embodiments of the present invention, in which a fluid guiding member 5 is further included, so that the working fluid 10 in the dispensing chamber 11 can be guided by the fluid guiding member 5 to the working surface of the mist actuator 42.

The fluid guiding member 5 can be made of a material providing capillary action, such as a fibrous material or a foamed sponge.

The working fluid 10 can be selected from the group consisting of water, perfume, aromatic, deodorant, insecticide, and any other activating fluids.

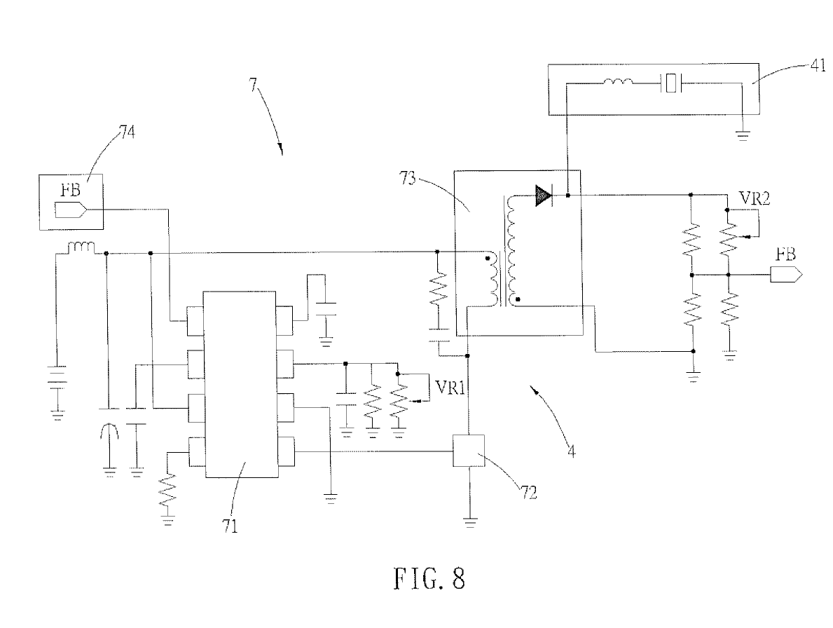

FIG. 8 is a circuit diagram of a driving circuit 7 for the atomizing module 4. As shown, the driving circuit 7 is a pulse-width-modulation (PWM) circuit consisting of a transformer converter and having an output acted on the piezoelectric element 41.

In the present invention, as can be seen in FIGS. 2 to 6, when the closed pressure container 2 is positioned upside down and then assembled to the port 13, a position of an open end 210 of the mouth 21 of the pressure container 2 or the lower end 130 of the port 13 relative to the level surface 100 forms either a clearance or a seal. Therefore, depending on whether the ambient atmospheric pressure enters into the pressure container 2 or not, the working fluid 10 in the pressure container 2 is automatically supplied to the dispensing chamber 11 under the action of the atmospheric pressure. As a result, the level surface 100 of the working fluid 10 stored in the dispensing chamber 11 is maintained at a constant height, allowing the working fluid 10 in the dispensing chamber 11 to have constant fluid pressure and constant fluid volume. That is, the atomizing module 4 has constant load, and accordingly, the produced mist (M) contains tiny droplets having constant volume, quality, and size. Therefore, the mist produced by the atomizing apparatus of the present invention has stable quality.

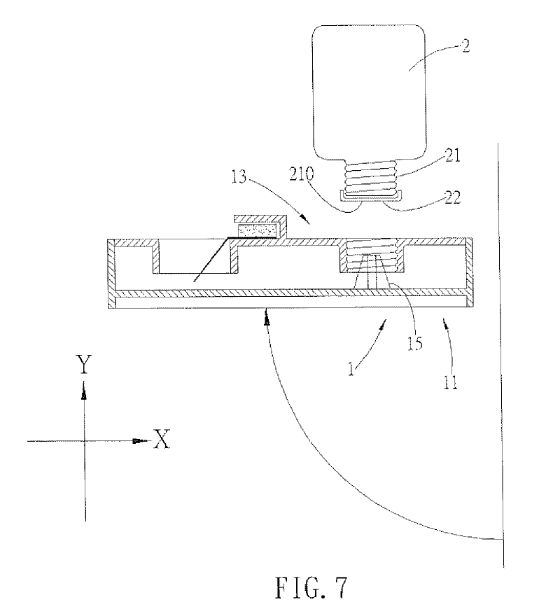

Please refer to FIG. 7. In the event the pressure container 2 is a standardized product, a general passive-type on/off valve can be provided at the open end 210. Alternatively, a breakable sealing membrane 22 made of aluminum foil or a plastic material, for example, can be provided at the open end 210 to seal the same. To assemble the pressure container 2 to the port 13, first turn the pressure container 2 upside down, and approaches the mouth 21 downward to the port 13. When the mouth 21 of the pressure container 2 is interfered with the port 13, the on/off valve or the sealing membrane 22 at the open end 210 is pushed open or pierced through, respectively, by a push member 15 arranged in the dispensing chamber 11. At this point, the working fluid 10 in the pressure container 2 will flow through the mouth 21 into the dispensing chamber 11 until the level surface 100 of the working fluid 10 rises to seal the open end 210 of the mouth 21 or the lower end 130 of the port 13.

Please refer to FIG. 8. The driving circuit 7 drives the atomizing module 4 to operate. As shown, the driving circuit 7 consists of a microprocessor 71, a driving unit 72, a boosting unit 73, and a feedback unit 74. When being driven by the driving circuit 7, the feedback unit 74 controls the average current of the piezoelectric element 41 based on a detected average current size of the piezoelectric element 41, the microprocessor 71 outputs a PWM signal to actuate the driving unit 72, so that the boosting unit 73 raises the voltage of the circuit to thereby drive the piezoelectric element 41 to generate the oscillation energy for the mist actuator 42 to oscillate and thereby produce mist M.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A horizontal-type atomizing apparatus with automatically controllable working fluid level, the atomizing apparatus being horizontally seated on a surf ace and utilizing the principle of atmospheric pressure balance to detect ambient environmental conditions, so as to regulate an amount of mist that can be produced from a working fluid contained in the atomizing apparatus as well as a duration within which the atomizing apparatus operates continuously, and generate a warning signal for a user to timely replenishing the working fluid; the atomizing apparatus comprising:
a portable horizontal base for storing an amount of the working fluid therein; a dispensing chamber being formed in the horizontal base, and a port being formed on the base atop the dispensing chamber, such that a lower end of the port is suspended in the dispensing chamber; and, an atomizing chamber also being formed in the horizontal base to locate horizontally opposite to and communicate with the dispensing chamber;
an atomizing module being arranged on the horizontal base adjacent to the atomizing chamber for producing mist, regulating the duration for producing mist, and indicating a level of the working fluid in the dispensing chamber based on the detection of external environmental conditions; and the atomizing module further including a power control unit, a piezoelectric element, a mist actuator, and a detecting unit;
the power control unit being arranged inside the atomizing module for supplying electric power, controlling the production of mist, and regulating the amount of mist to be produced; and the power control unit being able to generate an enable signal to the piezoelectric element, and stopping the mist production when receiving a warning signal from the detecting unit;
the piezoelectric element providing a vibration source, and producing oscillation energy when receiving the enable signal from the power control unit;
the mist actuator being extended into the atomizing chamber to contact the working fluid directly or indirectly, and being perforated on a working surface to form a plurality of mist producing holes; and, the mist actuator being oscillated to produce mist at the mist producing holes when receiving the oscillation energy from the piezoelectric element; and
the detecting unit being arranged below the mist actuator for detecting the level surface of the working fluid in the dispensing chamber; and, the detecting unit generating a warning signal when the level surface is lower than a preset value;
wherein the mist actuator is connected to the piezoelectric element as a cantilever; and
a pressure container being used to contain the working fluid therein, and having a mouth for removably assembling to the port on the horizontal base; and the pressure container having assembled to the port being in an upside-down position, so as to guide the working fluid through the mouth into the dispensing chamber.

2. The horizontal-type atomizing apparatus with automatically controllable working fluid level as claimed in claim 1, wherein the atomizing module further includes an ambient atmospheric condition sensing unit for detecting atmospheric conditions in the environment surrounding the atomizing apparatus; whereby when an ambient atmospheric pressure lower than a preset value is detected by the ambient atmospheric condition sensing unit, the power control unit generates the enable signal for the piezoelectric element to generate the oscillation energy and the mist actuator to oscillate and produce mist continuously; and, when an ambient atmospheric pressure higher than the preset value is detected, the enable signal stops, and the detection continues.

3. The horizontal type atomizing apparatus with automatically controllable working fluid level as claimed in claim 1, wherein the atomizing module further includes an ambient atmospheric condition sensing unit for detecting movements of all objects into and out of the environment surrounding the atomizing apparatus; whereby when it is detected by the ambient atmospheric condition sensing unit that the number of movements of all objects into and out of the ambient environment of the atomizing apparatus is higher than a preset value, the power control unit generates the enable signal for the piezoelectric element to generate the oscillation energy and the mist actuator to oscillate and produce mist for at least one time.

4. The horizontal-type atomizing apparatus with automatically controllable working fluid level as claimed in claim 1, wherein the piezoelectric element is a disc or annular shape, and the mist actuator is provided on a working surface thereof with a plurality of mist producing holes; and wherein the working fluid in the dispensing chamber is guided to the working surface of the mist actuator via a fluid guiding member; and the fluid guiding member is made of a material providing capillary action and selected from the group consisting of a fibrous member and a foamed sponge.

5. The horizontal-type atomizing apparatus with automatically controllable working fluid level as claimed in claim 1, wherein the working fluid in the dispensing chamber is guided to the working surface of the mist actuator via a fluid guiding member, and the fluid guiding member is made of a material providing capillary action and selected from the group consisting of a fibrous member and a foamed sponge.

6. The horizontal-type atomizing apparatus with automatically controllable working fluid level as claimed in claim 1, wherein the working fluid is selected from the group consisting of water, perfume, aromatic, deodorant, insecticide, and any other activating fluids.

7. The horizontal-type atomizing apparatus with automatically controllable working fluid level as claimed in claim 1, wherein the atomizing module further includes a driving circuit, which is a PWM circuit consisting of transformer converter, and an output of the driving circuit acts on the piezoelectric element.

8. The horizontal-type atomizing apparatus with automatically controllable working fluid level as claimed in claim 1, further comprising a push member arranged in the dispensing chamber corresponding to the port on the base.
